(19) United States
(12) Patent Application Publication
(10) Pub. No.: US 2007/0237604 A1
(43) Pub. Date: Oct. 11, 2007

(54) Low tolerance threaded fastener

(76) Inventor: Bernhard M. Janitzki, Puebla (MX)

Correspondence Address: Paul M. Denk, Suite 170, 763 S. New Ballas Rd., St. Louis, MO, 63141, US

(21) Appl. No.: 11/732,991

(22) Filed: Apr. 5, 2007

Related U.S. Application Data
(60) Provisional application No. 60/790,065, filed on Apr. 7, 2006.

(51) Int. Cl. F16B 39/30

(52) U.S. Cl. 411/310

(57) ABSTRACT

A threaded fastener is having a raised area or bump on a threaded flank. The flank can be positioned on a nut or a bolt thread. The bump forces the mating threads at least on one flank to have near zero tolerance along the pitch line and thereby eliminating play. Also creating an interference which produces friction, thus providing resistance to loosening of thread members.

### CROSSREFERENCE

This nonprovisional patent application claims priority to the provisional patent application having Ser. No. 60/790,065, which was filed on Apr. 7, 2006.

### BACKGROUND OF THE INVENTION

This invention relates generally to threaded fasteners such as nuts and bolts and more particularly to threaded fasteners having an improved thread and reduced tolerances and improved fastening.

Threaded fasteners are well known to the art. One goal of threaded fasteners, particularly nut and bolt combinations, is to provide such a fastener that stays tightened and does not loosen in use. Generally accepted matching techniques result in tolerances between the nut and the bolt threads and there is clearance or play which allows for movement between the elements. For example, a fastener or nut and bolt can loosen under load or vibration.

There are several prior art systems that try to remedy this problem. First, locknuts are used with a nylon washer locked in the end of the nut. When the nylon washer contacts the bolt, it tightens around the thread and locks the nut in position. Locknuts have disadvantages. The nylon portion of the nut has no load carrying threads. Further, it requires more material to make the nut longer and the nylon washer and the nut must be made separately and then crimped together. The locknut of this type can be used only a few times, is not as resistant to heat and requires chemicals i.e. nylon.

Deformed nuts have been used to overcome the loosening problem. These comprise nuts that are deformed out of the circular shape and made into rounded-off triangle shape. Then the bolt engages the threads, it contacts three points and the nut locks around the bolt. However, only heat-treated nuts can be used. To make the deliberate deformation requires an expensive manufacturing set-up. Further, the process is very slow. Also, the reaction of each individual nut is variable, which makes it difficult to predict or guarantee tolerances. Moreover, it can only be used with nuts.

A spiral lock is a lock thread is a commercially available alternative. However the spiral lock provides an interference on the outside diameter of the bolt. It is difficult to control the interference with accuracy. The surface of the bolt thread can cause galling of the nut and subsequent failure.

Interference-fit threads are used which include a complete interference of the matching parts at the flanks to provide an interference or metal flow. However, based upon accepted machining practices, it is very difficult to produce, for example, class 5 threads (Federal Standard Screw-Thread Standards for Federal Services-Class 5 Interference Fit Screw threads).

The inventor herein has obtained various previous United States and other patents relating to his concept for utilizing a bump on a thread flank, in order to attain a near zero tolerance of looseness between a nut and a bolt when secured together. For example, the U.S. Pat. No. 5,944,465, shows the use of a bump on a thread flank, in order to attain what is defined as a near zero tolerance along the pitch line of the threads to thereby eliminate play.

U.S. Pat. No. 6,190,101, also defines a zero tolerance threaded fastener, through the use of a raised portion upon the flank portion of a thread, wherein the raised portion is continuous throughout the substantial length of the thread when formed.

Finally, the U.S. Pat. No. 6,464,439, to the same inventor, is upon a low tolerance threaded fastener, wherein the threaded members, comprising either the bolt or the nut, has threaded portions that include first, second and third threaded portions, one which incorporates a standard thread, another which has standard roots flanks and crests, the second section having various sections of threads that are raised relative to the standard threads, in order to define what are called bumps, and the final section includes a third threaded section of standard threads.

Examples of prior art fastener technologies are disclosed in the following U.S. patents: U.S. Pat. No. 1,369,156, to Woodward; No. 2,842,180, to Brown et al: No. 3,459,250 to Tabor; No. 3,661,194, MacFarlane et al. No. 3,721,283, to Evan; No. 3,850,215, to Orlomoski; No. 3,927,503, to Wilson; No. 4,023,914, Holmes; No. 4,071,067, to Goldby; No. 4,396,321, Holmes; No. 4,846,614, to Steinbock; and No. 5,194,214, to Snyder et al.

Also disclosed a low tolerance threaded fastener which overcomes many of the above noted problems. The fastener disclosed in the U.S. Pat. No. 5,944,465 works well for its intended purpose. However it can be improved upon, specifically in the ease of performing its task.

### BRIEF SUMMARY OF THE INVENTION

It is among the principal objects of the present invention to provide a threaded fastener that is resistant to loosening.

It is another object of the present invention to provide a threaded fastener that has very close tolerances and is resistant to loosening.

Another object of the present invention to provide a threaded fastener that controls thread contact and tolerances along the thread pitchline.

Another object of the present invention to provide a threaded fastener that controls thread contact and tolerances along the thread pitchline and by controlling width of contact.

Still another object of present invention to provide such a threaded fastener that not only controls the pitch diameter of the respective threads to assure correct interference along the thread flank, but also controls the width of contact.

It is still another object of the present invention to provide such a threaded fastener that can be manufactured and produced in a broad range of sizes.

It is yet another object of the present invention to provide such a threaded fastener that is simple and economical to use, versatile and well suited for its intended purposes.

In accordance with the invention, a threaded fastener is provided having a raised area or bump on the flank.

The bump forces the mating threads at least on one flank to have near zero tolerances along the pitchline of the threads and thereby eliminating play. Also creating an interference which produces friction, thus providing resistance to loosening of the thread members.

### BRIEF DESCRIPTION OF THE DRAWINGS

FIG. 1 is a diagrammatic representation of engaged standard prior art threaded fastener threads;

FIG. 2 is a diagrammatic representation of a cross sectional view of a nut incorporating the thread of prior art low tolerance thread;

FIG. 3 is an enlarged fragmentary view of FIG. 2 showing a nut having the prior art low tolerance thread;

FIG. 4 is a diagrammatic representation of one embodiment of a standard bolt and a nut having the prior art low tolerance thread;

FIG. 5 is an enlarged fragmentary view of FIG. 4;

FIG. 6 is an enlarged fragmentary view of FIG. 5;

FIG. 7 is a diagrammatic representation of one embodiment of a standard bolt and a nut having the prior art low tolerance thread;

FIG. 8 is an enlarged fragmentary view of FIG. 7;

FIG. 9 is a diagrammatic representation of a cross sectional view of a nut having the thread of the present invention;

FIG. 10 is an enlarged fragmentary view of FIG. 9;

FIG. 11 is a diagrammatic representation of another embodiment of a standard bolt and nut having the thread of the present invention;

FIG. 12 is an enlarged fragmentary view of FIG. 11;

FIG. 13 is a diagrammatic representation of another embodiment of a standard bolt and a nut having the thread of the present invention;

FIG. 14 is an enlarged fragmentary view of FIG. 13.

Corresponding reference numerals will be used through-out the several figures of the drawings.

### DETAILED DESCRIPTION OF THE INVENTION

The following detailed description illustrates the invention by way for example and not by way of limitation. This description will clearly enable one skilled in the art to make and use the invention, and describes several embodiments, adaptations, variations, alternatives and uses of the invention, including what I presently believe is the best mode of carrying out the invention.

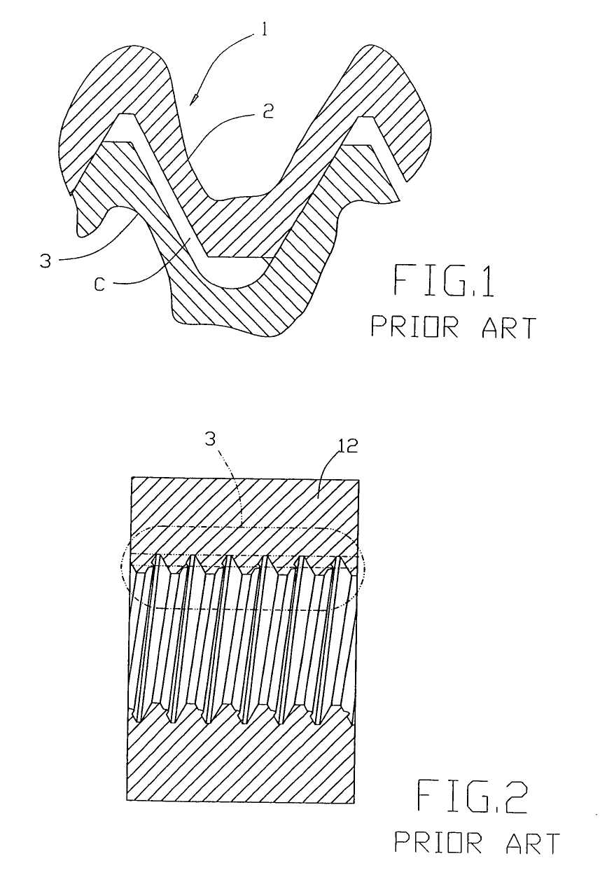

FIG. 1 illustrates a standard thread 1 with clearance C.

The clearance C defines the amount of play between a normal nut thread 2 and bolt thread 3. As will be appreciated, there are significant clearances C between the respective threads. Under irregular load conditions, the clearance C between the nut and the bolt threads can significantly increase. The amount of clearance is determined by the manufacturer.

FIG. 2 illustrates a threaded nut 12 having the thread form of the prior art low tolerance thread.

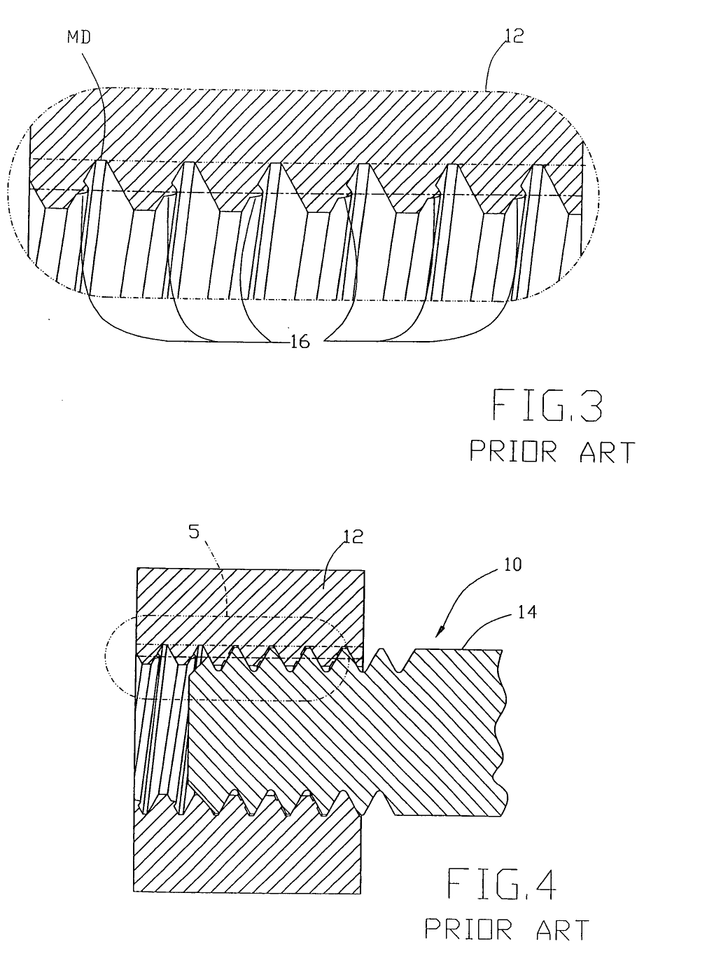

In FIG. 3 the raised portions or bumps 16 follow a pitchline parallel to the major diameter indicated by dotted line MD.

In FIG. 4 a threaded fastener 10 (such as a bolt screw, or other items having a threaded shaft) is shown received by nut 12. As is shown, the fastener 10 has a shaft 14.

In FIG. 5 the threads of bolt 10 crushing raised parts 16 of threads of nut 12 are shown in their flattened (extruded) form 18.

In FIG. 6 the first thread flank F of bolt 10, crushing (extruding or displacing) the full amount of material B of the raised part 16, leaving it in its shape 18 is shown.

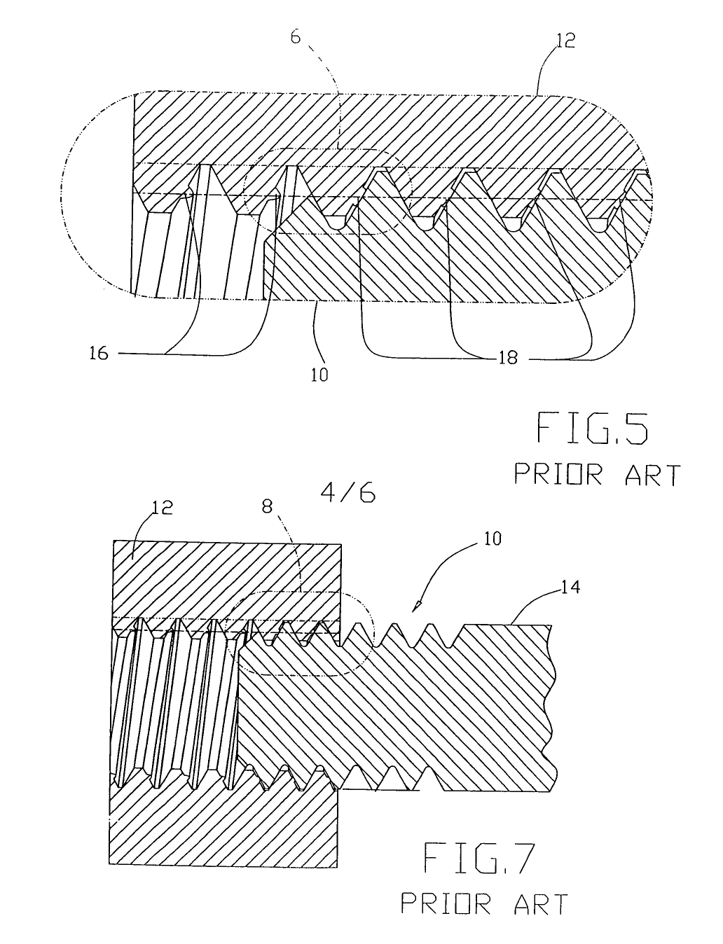

In FIG. 7 a threaded fastener 10 is shown received by nut 12.

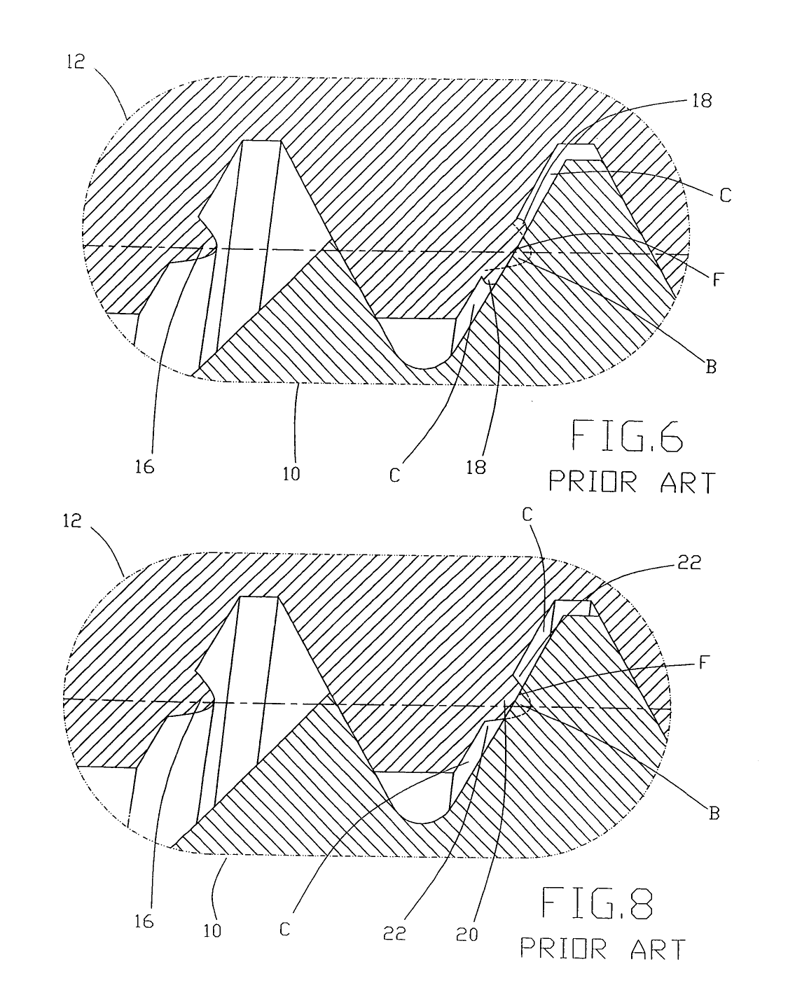

In FIG. 8 the first flank F of bolt 10 does not crush (extrude or displace) the full amount of material B of the raised part 16, like it did in FIG. 6, but shears or scrapes it off. Thus no material is pushed into the clearance 22 and only the desired zero play condition is guarantied but the screw embodiment does not produce enough friction to result in a lock thread.

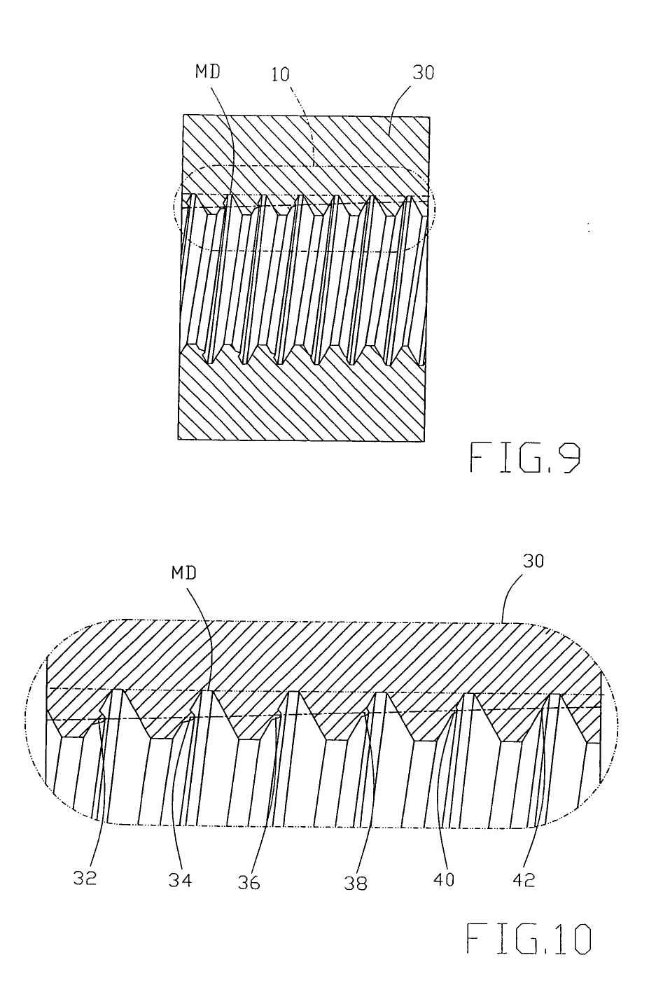

In FIG. 9 a threaded nut 30 having an altered low tolerance thread form representing the invention is shown.

In FIG. 10 the raised parts are placed in a continuously declining (tapered) pitchline. Maintaining the same pitch of the tool (tap, forming tool or thread rolling dies) diminishes the raised parts 32, 34 36, 38 40 and 42 because of the tapered pitchline.

In FIG. 11 a threaded bolt 10 entering a nut 30 by three turns is shown.

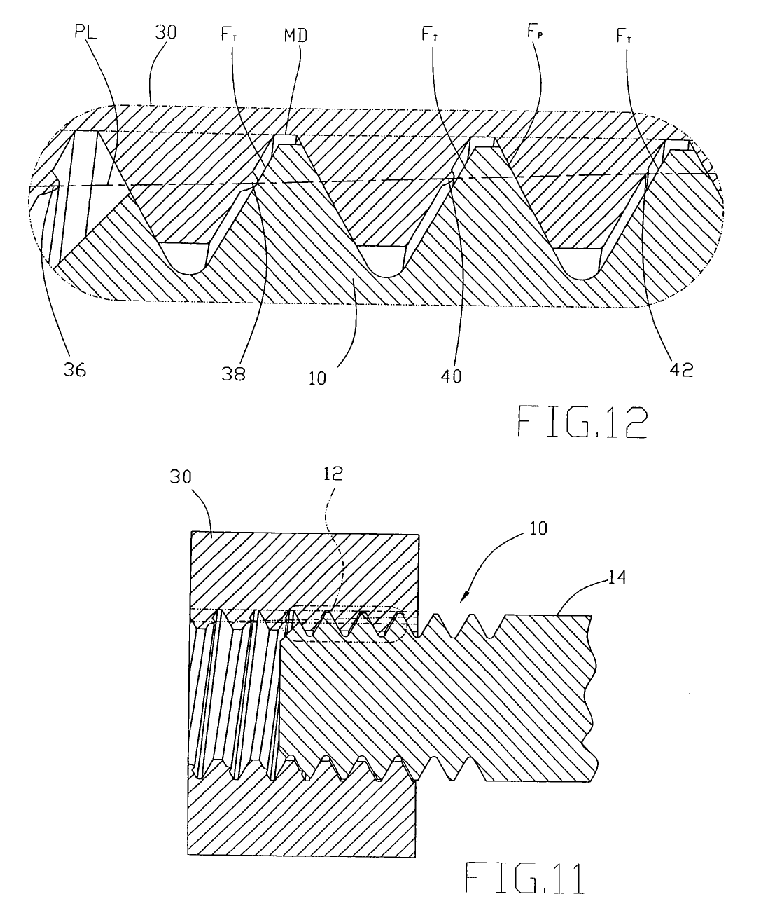

In FIG. 12 the raised parts on the threads 40 and 42 of nut 30 are shown not touching flanks Ft of bolt 10 while flank Fp is engaged. Raised part 38 barely touches flank Ft. what the invention accomplishes is a free entrance of the screw without starting to crush the first thread like is the case shown in FIG. 6.

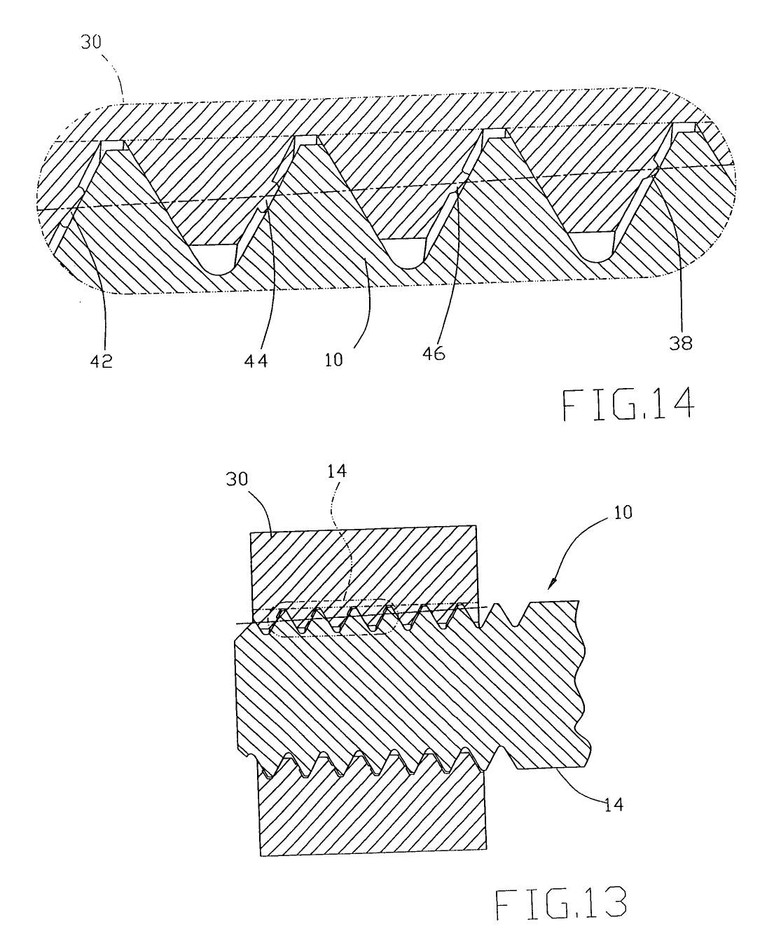

In FIG. 13 bolt 10 penetrating nut 30 fully is shown.

In FIG. 14 bolt 10 having gradually crushed raised parts 42, 44 and 46 of nut 30 are shown.

The tapered pitchline of raised parts or bumps on the thread flanks, of the present invention preserves the low tolerance zero play condition which is obtained by the fastener in my prior patent, U.S. Pat. No. 5,944,495 which is incorporated herein by reference. However, the present invention allows the bolt to enter freely any amount of turns according to the depth of the tapered bumps. This can easily be accomplished by tapping deeper into the threaded part or altering the threading tools like, thread rolling dies for screw threads or taps and forming taps for internal threads.

This is of advantage to start threads safely in automated assembly and preventing misalignments.

Which is not always possible with threads that start with a radial torque from the first engagement, like thread forming screws or low tolerance threaded screws.

In thread assemblies of heat treated steels where a gradual increase of contact pressure is more convenient and will not damage the contact areas.

Lock threads are generally expected to comply with international specifications like IFI 100/107 and ISO 2320.

This is more difficult with threads that start since the very engagement of the thread members to generate a high torque.

Thread forming screws generate usually more than twice the maximal permitted torque of the first entrance established by the mentioned specs.

One of the major applications of the invention is intended for applications in nonferrous materials like brass, copper, aluminum or die cast parts.

In many of these applications a steel screw is introduced into threads made in nonferrous materials. It can easily happen that the screw scrapes off the material while engaging with the opposing thread member when applying it to the original low tolerance thread. Mainly because of differences in material strengths and that the raised parts (bumps) extent cylindrical or parallel to the centerline of the thread members.

The gradually increments of contact of the raised flank parts of the invention overcomes this problem and easily stays within the specs.

The tapered pitchline raised flank parts can be made in either metal fasteners, nuts, pipes etc. and plastic parts.

As is apparent from the forgoing description, the tapered raised flank parts can be formed on exterior and interior threads.

The essence of this invention is to provide both a threaded bolt, and a threaded nut, where the threaded bolt is capable of threadedly engaging within the threaded nut, wherein the threads on one of the threaded bolt and threaded nut are disposed to engage the threads on the other of said threaded bolt threaded nut, in order to sustain a zero tolerance of looseness during extended usage. But, in order to provide for a proper seating of the bolt within the nut, the raised portion extending approximately upon the flank portion of one of the threads, tapers from a minimum at the entrance point of the bolt or nut, until it raises up to provide for tight contact with the flank of the thread of the other nut or bolt, in order to minimize, once tightened within the other, the clearance between the respective threads when engaged.

The raised part of the tapering portion of the threads may extend over the entire length of the bolt, and such tapered portion may extend from a low point at the commencement of the threads, at the tip of the bolt, and rise up to a full raised portion at approximately at mid-point of the length of the bolt, or to some other dimension, that there may also be consistent raised portions of the thread that will provide for zero tolerance fitting of the bolt, within the nut, or vice versa, in usage and operation of this fastener.

As various changes could be made in the construction without departing from the scope of the invention, it is intended that all matter contained in the above description or shown in the accompanying drawings shall be interpreted as illustrative and not a limiting sense.

1. A threaded fastener comprising:
a threaded bolt having external threads;
a threaded nut having internal threads;
said threaded bolt capable of threadedly engaging within said threaded nut;
the threads of one of said threaded bolt and threaded nut disposed to engage the threads on the other of said threaded bolt and threaded nut, in order to sustain a zero tolerance of looseness during extended usage, said threads being formed having a raised area approximately upon the flank portion of its thread, said raised portion extending approximately upon the flank portion of said thread, said raised portion extending approximately perpendicularly from said flank portion throughout its extent of the said thread flank portion, and arranged approximately at the midpoint of said threaded flank portion, said raised area of the flank portion of said threads having a tapering configuration, with the least taper for the raised portion at the entrance point of the threads of the threaded nut or bolt, and extending to a fully raised area of the thread flank portion of said threads minimizing the area of clearance between the respective threads when engaged, so as to provide for an approximate zero tolerance of looseness between the threaded bolt and the threaded nut when they are fully engaged.

2. A threaded fastener comprising a threaded bolt having external threads, said threaded bolt capable of threadily engaging within a threaded nut, the threads of said threaded bolt disposed to engage the threads on the threaded nut, in order to sustain a zero tolerance of looseness during extended usage, said threads of the threaded bolt being formed having a raised area approximately upon the flank portion of its thread, and raised portion extending approximately perpendicularly from said flank portion throughout its extent of said thread flank portion, and arranged approximately at the mid point of said threaded flank portion, said raised area of the flank portion of said thread having a tapering configuration, with a least taper for the raised portion at the entrance point of the threads of threaded bolt, and extending to a fully raised area of the threaded flank portion of said threads are minimizing the area of clearance between the respective threads when engaged, so as to provide for an approximate zero tolerance of looseness between the threaded bolt and the threaded nut when they are fully engaged.

3. A threaded fastener comprising, a threaded nut having internal threads, a threaded bolt having external threads, said threaded nut capable of threadily engaging said threaded bolt, the threads of said threaded nut dispose to engage the threads on the threaded bolt, in order to sustain a zero tolerance of looseness during extended usage, said threads being formed having a raised area approximately upon the flank portion of its thread, said raised portion extending approximately perpendicularly from said flank portion throughout its extent of said thread flank portion, and arranged approximately at the mid-point of said threaded flank portion, said raised area of the flank portion of said threads having a tapering configuration, with the least taper for the raised portion at the entrance point of the threads of the threaded nut, and extending to a fully raised area of the thread flank portion of said threads minimizing the area of clearance between the respective threads when engaged, so as to provide for an approximate zero tolerance of looseness between the threaded nut and the threaded bolt when they are fully engaged.

4. Threaded fastener of claim 1 wherein raised area of the threads may extend over the entire length of the threaded bolt or threaded nut.

5. The threaded fastener of claim 1 wherein raised area of the threads may extend from the tip of the bolt or entrance into the threaded nut and extend in a tapered manner until the opposite end of the said bolt and nut.

6. Threaded fastener of claim 1 wherein the tapering portion of the raised area of the threads for either the tapered bolt or tapered nut may extend some portion of the entire length of the threads, and then uniformly integrate into continuous raised area of the same dimension for the remaining portion of the threaded bolt or threaded nut.
